(19) United States
(12) Patent Application Publication
(10) Pub. No.: US 2009/0155530 A1
(43) Pub. Date: Jun. 18, 2009

(54) METHODS FOR SURFACE ACTIVATION OF WOOD-FIBER REINFORCED THERMOPLASTIC COMPOSITES FOR SURFACE ADHESION ENHANCEMENT AND COMPOSITES HAVING SUCH SURFACE PROPERTIES

(76) Inventors: Marie-Pierre G. Laborie, Pullman, WA (US); Barun S. Gupta, Trondheim (NO)

Correspondence Address: PERKINS COIE LLP;PATENT-SEA, P.O. BOX 1247, SEATTLE, WA, 98111-1247, US

(21) Appl. No.: 12/265,604

(22) Filed: Nov. 5, 2008

Related U.S. Application Data
(60) Provisional application No. 60/985,440, filed on Nov. 5, 2007.

(51) Int. Cl. B32B 3/00; B44C 1/22; B29C 67/00

(52) U.S. Cl. 428/141; 204/164; 204/157.15; 216/83; 264/80

(57) ABSTRACT

Methods for surface modification of wood-fiber reinforced thermoplastic composites (WPCs) for improving surface adhesion of a water-based acrylic coating and composites having such surface properties are disclosed herein. In one embodiment, the surface of WPC formulations can be modified using one or more surface treatments including chromic acid treatment, oxygen plasma treatment, Benzophenone/UV treatment, and flame treatment. In another embodiment, WPC material can be sequentially treated with chromic acid and oxygen plasma to roughen the WPC material surface and increase the WPC surface wettability with polar liquids. In some embodiments, an acrylic coating peel load increased approximately 64% to approximately 170% following surface modification.

### CROSS-REFERENCE TO RELATED APPLICATIONS

The present application claims priority to U.S. Provisional Patent Application No. 60/985,440 filed Nov. 5, 2007, entitled “METHODS FOR SURFACE ACTIVATION OF WOOD-FIBER REINFORCED THERMOPLASTIC COMPOSITES FOR SURFACE ADHESION ENHANCEMENT AND COMPOSITES HAVING SUCH SURFACE PROPERTIES,” and incorporated herein in its entirety by reference.

### STATEMENT REGARDING FEDERALLY SPONSORED RESEARCH

This work was partially funded by the Office of Naval Research (Grant No.: N00014-03-1-0949), and the United States government has, therefore, certain rights to the present invention.

### TECHNICAL FIELD

Aspects described herein relate generally to adhesion properties of wood plastic composite materials and more particularly to methods for improving the adhesion properties of the same.

### BACKGROUND

With the growing utilization of wood fiber reinforced thermoplastic polymer composites (WPCs) in exterior applications, and the durability issues associated with these materials, paints and coatings are being considered as a means for improving their resistance to weathering. Recent studies focused on the surface and adhesion characteristics of WPCs have repeatedly reported low adhesion levels of coatings and adhesives. Poor adhesion has been attributed to the concentration of polyolefin on the surface which results in hydrophobic, low surface energy substrates.

### BRIEF DESCRIPTION OF THE DRAWINGS

FIG. 1 is a graphical representation of ATR-FTIR spectra of a HDPE/Pine/MAPP formulation both before and after surface treatments.

FIG. 2 illustrates an advancing contact angle of WPC formulations both before and after surface treatments.

FIG. 3 is a graphical representation of surface topography of a HDPE/Pine/MAPP formulation both before and after surface treatments.

FIGS. 4(a)-(e) are, respectively, scanning electron microscopy (1.5 K magnification) images of a HDPE/Pine/MAPP formulation a) before treatment, and after treatments with b) chromic acid, c) flame, d) BP/UV and e) oxygen plasma.

FIG. 5 is a graphical representation of the peel load (N/m) dependency of WPC formulations on wetting hysteresis.

### DETAILED DESCRIPTION

### A. Overview

A process for improving the adhesion properties of wood plastic composites is described herein. Certain aspects of this disclosure relate to various surface activation methods for improving adhesion properties of wood plastic composites.

In some aspects of the present disclosure, the adhesion properties of WPCs are enhanced by the following surface activation methods and/or combinations of the following: 1) oxygen plasma treatment; 2) flame treatment; 3) chromic acid treatment; 4) combination of benzophenone/UV irradiation treatment.

### B. Embodiments of WPC Surface Treatment Methods

Surface activation methods comprising post extrusion modification of WPC materials to provide a WPC with properties that enable the adhesion of paints are described herein in accordance with embodiments of the disclosure.

In one embodiment, oxygen plasma can be generated in a cylindrical reactor with a coil operating at a specific radio frequency (e.g., 12-15 MHz), temperature (e.g., 20-25° C., room temperature, etc.) and base pressure (e.g., less than 3×10⁻⁶ MPa, about 0.2×10⁻⁶-2.1×10⁻⁶ MPa, etc.). In one arrangement, WPC products can be treated in the center of the coil, for example, in a single, timed exposure (e.g., approximately 5 minutes to approximately 60 minutes).

In another embodiment, Flame treatment can be performed with a flame generator. Air and natural gas can be mixed in a venturi-tube to generate a flame from a ‘T’ type utility ribbon burner. WPC material can be moved under the flame, at a determined distance from the burner edge (e.g., approximately 5 mm to approximately 50 mm). The WPC material can be moved at determined speed, such as a constant speed of approximately 0.1 m/s to approximately 0.9 m/s.

In yet another embodiment, chromic acid treatment can be used to treat WPC surfaces. In some embodiments, this method can include immersing WPC products in a stirred chromic acid, after which the samples can be washed in distilled water and dried. In other embodiments, chromic acid may be applied to the surface without full immersion.

In a further embodiment, benzophenone/UV irradiation treatment can be used to activate WPC surfaces. In some embodiments, this method can include immersing WPC products in benzophenone (BP) in acetone. The immersion may be brief, for example, approximately 0.5 minutes to approximately 5 minutes. Following immersion, the solvent can be allowed to evaporate. The WPC material can then be irradiated under a UV lamp source, such as a metal halogenide lamp for approximately 1 minute to approximately 5 minutes. The treatment method can also include washing the sample with acetone to remove residual BP.

Treatments with chromic acid and oxygen plasma can increase the WPCs acrylic coating peel load by approximately 170% and approximately 122%, respectively, and can yield adhesion levels equivalent to or higher than those obtained on wood. The benzophenone/ultraviolet and flame treatments can also improve the coating adhesion by approximately 100% and approximately 64%, respectively, but may not reach the adhesion levels achieved on wood. The WPC formulation can affect both the chromic acid and oxygen plasma treatment efficacy. Profilometry and scanning electron microscopy of the WPC surfaces following treatment (discussed below) have shown that the chromic acid treatment can roughen the WPC surfaces. While surface oxidation has not been evident from attenuated total reflection Fourier transform infrared spectroscopy (ATR-FTIR) (discussed in detail below), the improved wettability of WPCs with water suggests that the oxygen plasma treatment can oxidize WPCs.

In one embodiment, chromic acid and oxygen plasma treatments can efficiently improve the adhesion of an acrylic coating on WPCs. With the chromic acid treatment, the surface roughness of WPC can increase with the formation of large crevasses formed on the surface. In some arrangements, surface roughening can be accompanied with a decrease in the surface wood index which can suggest that chromic acid may etch the wood components. Regardless, the increase in surface roughness induced by chromic acid treatment results in a higher interfacial area for bonding and possibly greater energy dissipation mechanisms for plastics. In addition, greater surface roughness may also contribute to mechanical interlocking at the interface and change the stress distribution. Without being bound by theory, the above-described adhesions mechanisms may be the primary mechanisms operating as a result of chromic acid treated WPC. While it may be possible that surface oxidation occurs as a result of chromic acid treatment, as is expected on polyolefins, this has not been detected with ATR-FTIR.

In another embodiment, oxygen plasma treatment of WPC surfaces improves water wettability, suggesting higher hydrophilicity of the surface. The improvement in water wettability may be imparted by an oxidizing effect of the oxygen plasma treatment. Oxygen-containing functional groups on the WPC surface can give rise to polar interactions with the acrylic coating, through primary bonding or secondary interactions such as H-bonding. Enhanced wettability is also important to achieve molecular contact between the substrate and the liquid coating upon application. Higher surface polarity and greater wettability may, therefore, explain the high efficacy of the oxygen plasma treatment on WPCs.

In another embodiment, successive implementation of each treatment or combinations of treatments can be used to further improve the coating adhesion to WPCs. For example, considering that the chromic acid treatment and the oxygen plasma treatments enhance coating adhesion via distinct mechanisms, these processes can be used to treat the same WPC surfaces and further improve the surface activation and adhesion properties.

It is to be understood that the surface treatment and methods applied to provide surface activation will depend on the specific composition of the WPC. Generally, these include methods and/or chemical agents that serve to provide a surface with an enhanced affinity toward water.

The disclosure is further illustrated but is not intended to be limited by the following examples.

### C. Examples

### C1. WPC Formulations

The manufacture of WPCs has been previously described (Gupta et al., M.-P. G., 302 388-395[2007], which is incorporated herein by reference in its entirety). Briefly, a 2³ factorial design can be used to design WPC formulations including either pine (Pinus spp.) or maple (Acer spp.), either high density polyethylene (HDPE, Innovene Inc., Chicago, Ill.) or isotactic polypropylene (PP, Equistar, Houston, Tex.), and with or without a maleic anhydride grafted polypropylene (MAPP, Honeywell, Morristown, N.J.) coupling agent (Table 1). This factorial design was developed so that the impact of polymer selection (HDPE vs. PP), wood species selection (pine vs. maple) and presence of coupling agent could be evaluated in specific examples. The formulations also comprised a commercial lubricant (OP100, Honeywell, Morristown, N.J.) and talc (Nicron 403, from Luzenac America Inc., Centennial, Colo.). A water-based white acrylic coating (Raykote 2000, sp. gravity 10.57 and coating VOC 132.67) was supplied by Drew Paints, Inc. (Portland, Oreg.) for testing the paint adhesion to WPCs.

TABLE 1
WPC Formulations

| Polyolefin (wt. %) | Wood Species (wt. %) | Coupling Agent (wt. %) |
|---|---|---|
| HDPE (33.8) | Pine (59) | MAPP (2.3) |
| HDPE (33.8) | Maple (59) | MAPP (2.3) |
| PP (33.8) | Pine (59) | MAPP (2.3) |
| PP (33.8) | Maple (59) | MAPP (2.3) |
| HDPE (36.1) | Pine (59) | — |
| HDPE (36.1) | Maple (59) | — |
| PP (36.1) | Pine (59) | — |
| PP (36.1) | Maple (59) | — |

All formulation components were first dry blended and then fed into a 35 mm intermeshing twin screw extruder (Cincinnati Milacron, Cincinnati, Ohio) operating at an approximate 5-8 rpm screw speed, approximate 3.45-5.52 MPa melt pressure and equipped with a water-spray cooler. The barrel and die temperatures were 163° C. and 171° C. for HDPE formulations and 185-193° C. and 185° C. for PP formulations, respectively. Rectangular sections (10×38 mm²) were extruded and samples (1×9×36 mm³) were milled from the center of the WPC cross-sections to obtain homogeneous surfaces from the bulk. The sample surfaces were refreshed as recommended in ASTM D2093 prior to surface treatments and characterization, or control sample characterization. Sufficient material was prepared in order to obtain at least 4 samples to test with each surface characterization technique as well as for adhesion measurements with the acrylic coating. In addition solid maple (Acer spp.) wood was used as a control surface.

### C2. Surface Treatments

WPC surface modification methods were evaluated for high density polyethylene (HDPE) and isotactic polypropylene (PP) formulations with or with out maleic anhydride grafted polypropylene (MAPP). Some embodiments of methods include the following treatments: 1) oxygen plasma, 2) flame, 3) chromic acid and 4) Benzophenone/UV irradiation (BP/UV).

(1) Oxygen plasma was generated in a cylindrical reactor with a coil operating at a radio frequency of about 13.56 MHz, room temperature and base pressure in the range of about 0.2×10⁻⁶ to about 2.1×10⁻⁶ MPa. Four replicates of each WPC formulation were placed in the center of the coil and treated in a single run. HDPE formulation samples were treated for approximately 30 minutes at about 0.013×10⁻³ MPa pressure, about 52 sccm oxygen flow rate. PP formulation samples were treated at about 0.011×10⁻³ MPa pressure, about 10 sccm oxygen flow rate for approximately 10 minutes.

(2) Flame treatment was performed using a flame generator from Ensign Ribbon Burners LLC (Pelham Manor, N.Y.). Air (approximately 2.9 kPa) and natural gas (approximately 3.7 scfm) were mixed in a venturi-tube to generate a flame from a ‘T’ type utility ribbon burner. Samples were manually moved under the flame, at approximately 12 mm distance from the burner edge, and at an approximate speed of ˜0.3 m/s.

(3) Chromic acid treatment included an approximate 2 minute immersion of the samples in a fresh chromic acid solution maintained at approximately 70° C. and under constant stirring (e.g., in accordance with ASTM D2093-03). Following immersion, the samples were washed in distilled water and dried in a oven at approximately 40° C. for about 1 hour.

(4) Benzophenone/UV irradiation treatment included an approximate 1 minute immersion of the samples in an approximate 5% weight solution of benzophenone (BP) in acetone. Following solvent evaporation, the samples were irradiated for about 2 minutes under a metal halogenide lamp (Heraeus 380 watt, Hanau, Germany) using an approximate 20 cm substrate-to-source distance. The samples were washed with acetone (to remove extra BP) and kept in glass vials wrapped with aluminum foils to avoid further exposure to light until characterization.

### C3. Surface Characterization

Control and treated samples were characterized to evaluate the changes in surface chemistry, wettability and topography following WPC surface treatment.

The surface chemistry was first characterized with attenuated total reflection Fourier transform infrared spectroscopy, ATR-FTIR using a ZnSe crystal (Thermo Nicolet Continuum model, Fitchburg, Germany, MCT-A detector, incident angle of 45±5°). For each sample, 560 scans were acquired at about 4 cm⁻¹ resolution. A surface wood index, OH/CH, was obtained by normalizing the cellulosic hydroxyl peak intensity at approximately 1023 cm⁻¹ to the polyolefinic C—H stretching peak intensity at approximately 2912 cm⁻¹.

Contact angle measurements were then performed on a dynamic contact angle analyzer, DCA, (Cahn 322, Thermo Scientific, Waltham, Mass.) using water as a probe liquid (Lγ=72.8 mJ/m²) and a stage moving at an approximate speed of 194 μm/s. Advancing and receding contact angles, θₐ and θᵣ, were measured along with the wetting hysteresis (cos Lγθₐθᵣ−cos).

The surface topography of the HDPE/Pine/MAPP formulation was also evaluated with a diamond stylus profilometer (SPN Technology Inc., Goleta, Calif.) using a force of approximately 9.8.10⁻⁶ N and an approximate scanning rate of 0.4 mm/sec on 10 mm long scan. Finally, these samples were imaged on a Hitachi scanning electron microscope (SEM, Tokyo, Japan) after gold coating (about 20 kV).

### C4. Adhesion Test

The acrylic coating was applied on the WPC surfaces using a wire wound draw down bar (#32, Diversified Enterprises, Claremont, N.H.) and a strip of gauze, approximately 9 mm wide, was placed on the wet coated surface after which the coating was cured at room temperature for about 1 hour. A second layer of coating was then applied and cured at room temperature for approximately 48 hours. The free end of the gauze was wrapped with a mask tape and placed into tensile grips on an Instron testing machine (model 4426, Norwood, Mass.) to undergo a 180° adhesion test (“the peel test”). The peel test was conducted at an approximate crosshead speed of 20 mm/min. Peel load (N) was normalized to a sample width of 10³ mm according to the ASTM.

### C5. Statistical Analysis

The data were analyzed in a randomized complete block design (CBD), using the eight different formulations as a blocking factor. The effect of treatments on all measured properties was detected with a one-way analysis of variance (ANOVA) and Duncan's multiple test using α=0.05. For the peel load only, an ANOVA was also performed within each treatment dataset at α=0.1 to detect the impact of formulation factor on the peel load. Finally, qualitative comparison of scanning electron microscope (SEM) images and topographic profiles from before and after treatments was performed for the HDPE/Pine/MAPP formulation.

### D. Analysis of Examples

### D1. Impact of Surface Treatments on the Adhesion of an Acrylic Coating

Table 2 summarizes the peel strength of the acrylic coating on WPCs before and after the surface treatments. When evaluated across all formulations, the above described embodiments of treatment methods significantly improve the adhesion of the acrylic coating to WPCs. In these examples, however, there were significant differences in the efficacy of the various surface activation methods. Specifically, in the examples described above, the chromic acid treatment was the most effective treatment (637±88 N/m), followed by the oxygen plasma treatment (516±116 N/m) and then the BP/UV treatment (466±107 N/m). The flame treatment (381±94 N/m) was the least effective of the treatments. In fact, the chromic acid, oxygen plasma and BP/UV treatments more than doubled the adhesion strength of the acrylic coating to WPCs as compared to the adhesion strength demonstrated for control WPCs (232±56 N/m). Specifically, the chromic, O₂ plasma and UV/BP increased the average peel load of the samples by 175%, 122% and 100%, respectively. The flame treatment increased the average peel load of the samples by 64%. Moreover, the coating adhesion to chromic acid or oxygen plasma treated WPCs was in the same range as that to maple (524±64 N/m) and well above that of neat plastic (48-126 N/m). Moreover, following treatment with chromic acid or oxygen plasma, WPCs can be coated with equal or greater efficiency than maple wood.

TABLE 2
Peel Strength of Acrylic Coating on WPCs Before and After Surface Treatments

| Formulation | Control | Flame | Chromic | PB/UV | O₂ Plasma |
|---|---|---|---|---|---|
| HDPE/Pine/Mapp | 177 ± 21 | 317 ± 50 | 667 ± 74 | 462 ± 96 | 545 ± 89 |
| HDPE/Maple/Mapp | 168 ± 13 | 356 ± 12 | 631 ± 79 | 516 ± 14 | 502 ± 109 |
| PP/Pine/Mapp | 232 ± 9 | 483 ± 214 | 707 ± 67 | 460 ± 130 | 460 ± 71 |
| PP/Maple/Mapp | 249 ± 9 | 362 ± 30 | 711 ± 77 | 389 ± 124 | 478 ± 160 |
| HDPE/Pine | 218 ± 16 | 372 ± 37 | 583 ± 26 | 429 ± 96 | 549 ± 164 |
| HDPE/Maple | 217 ± 23 | 412 ± 94 | 639 ± 57 | 449 ± 67 | 430 ± 62 |
| PP/Pine | 290 ± 24 | 336 ± 71 | 642 ± 71 | 461 ± 65 | 646 ± 20 |
| PP/Maple | 309 ± 20 | 410 ± 7 | 514 ± 100 | 561 ± 183 | 609 ± 8 |
| Maple | 524 ± 64 | — | — | — | — |
| PP | 126 ± 35 | — | — | — | — |
| HDPE | 48 ± 1 | — | — | — | — |
| AVERAGE* | 232 ± 56(E) | 381 ± 94(D) | 637 ± 88(A) | 466 ± 107(C) | 516 ± 116(B) |
| Significant Factors | No MAPP | — | MAPP | — | No MAPP |
| (level giving highest | PP | | | | PP |
| peel load is noted) | | | | | |

*Average across all WPC formulations. Letter indicates grouping from the Tukey-test from high (A) to low (E) values.

In some arrangements, formulations without MAPP coupling agent can be more effectively coated than formulations with MAPP. As shown in Table 2, higher peel strength on MAPP-devoid formulations correlated with greater surface roughness which can favorably affect adhesion. Similarly, PP formulations developed higher peel loads than HDPE formulations, possibly due to the higher surface wood index and polarity observed in the PP formulations. To further evaluate the impact of WPC formulation factors on the efficacy of each treatment, ANOVA was conducted within each dataset (Table 2). For the plasma treatment, the impact of formulation factors on the acrylic peel load was similar to that in control WPCs. For example, formulations without MAPP developed higher peel loads to the acrylic coating. Additionally, PP formulations developed higher peel loads to the acrylic coating when compared to HDPE. This suggested that the plasma treatment did not differentially improve the surface and adhesion properties of WPC formulations. In contrast, following the chromic acid treatment, formulations that contained MAPP developed higher peel loads than formulations without MAPP (Table 2). This differed with the adhesion trend demonstrated by the control WPC samples, indicating that the chromic acid treatment can more effectively improve the adhesion of formulations containing MAPP. Neither the BP/UV nor the flame treatments demonstrate formulation dependency of the peel load. For example, following the BP/UV and flame treatments, all formulations could be equally bonded by the acrylic coating.

To conclude, although the above-described embodiments of surface treatment methods can effectively improve the coating adhesion to WPCs, their efficacy can vary as well as depend on the WPC formulation. The differential effects of the treatments on WPC formulations suggested that different adhesion mechanisms may be relevant. To shed light on the mechanisms by which each treatment improved the coating adhesion, the surface properties of the treated WPCs were evaluated for each sample and in accordance with an embodiment of the disclosure.

### D2. Impact of Surface Treatments on WPC Surface Chemistry

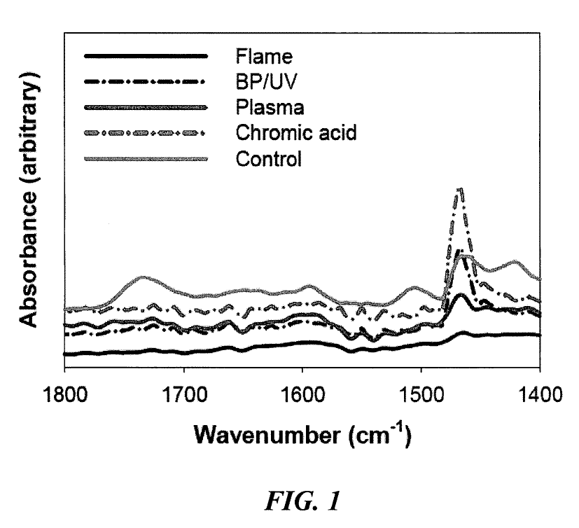

FIG. 1 is a graphical representation of ATR-FTIR spectra of a HDPE/Pine/MAPP formulation both before and after surface treatments. In contrast to conventional thought, the ATR-FTIR spectra of all sample WPCs following treatment did not clearly reveal surface oxidation at the carbonyl region in the 1530-1840 cm⁻¹ region (FIG. 1). In fact, a carbonyl band is observed at 1725 cm⁻¹ in the untreated sample only and may be due to lignin, suggesting that the treatments may have induced a loss of wood component on the surface. While oxidation may occur on WPC surfaces upon treatment, it may not be significant enough to be observed with ATR-FTIR.

Table 3 demonstrates that the OH/CH ratio, or wood index, was clearly altered by most surface treatments. Specifically, treatments with chromic acid, BP/UV and, to a lesser extent, with flame decreased the surface wood index or increased the concentration of plastic on the first few microns of the surface as probed by ATR-FTIR. The lowering of the wood index following these treatments may have been caused by etching of the wood components, or by temperature-induced migration to the surface of the C—H rich components.

TABLE 3
OH/CH Ratio (Wood Index), θₐ, θᵣ and Wetting Hysteresis
Measurements Before and After Surface Treatment

| | | | | Wetting |
|---|---|---|---|---|
| | | | | Hysteresis |
| Treatment | O—H/C—H | θₐ(°) | θᵣ(°) | (mJ/m²) |
| Control | 2.11 ± 0.77 (A)* | 100 ± 7 (C) | 23 ± 14 (A) | 78 ± 12 (D) |
| Flame | 1.70 ± 0.56 (B) | 104 ± 14 (C) | 0 | 90 ± 17 (C) |
| Chromic | 1.01 ± 0.46 (C) | 120 ± 19 (B) | 0 | 107 ± 20 (B) |
| BP/UV | 1.25 ± 0.69 (C) | 140 ± 10 (A) | 0 | 128 ± 8 (A) |
| O₂ Plasma | 1.97 ± 0.91 (A) | 35 ± 14 (D) | 0 | 71 ± 11 (E) |

*Letter indicates grouping from the Tukey-test from high (A) to low (E) values.

### D3. Impact of Surface Treatments on WPC Surface Wettability

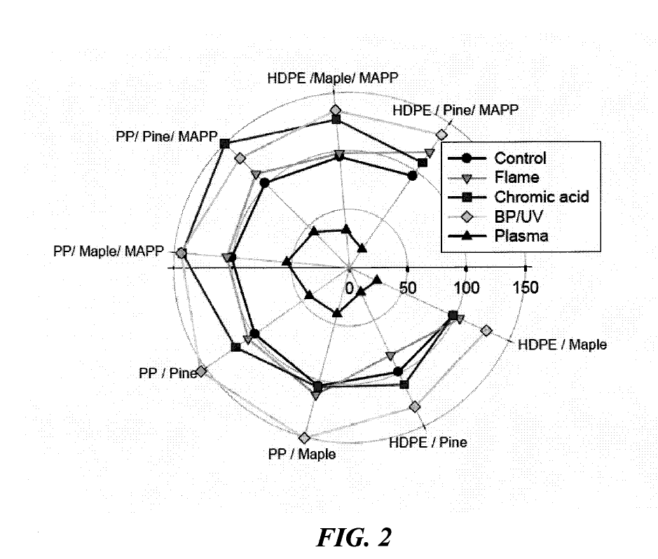

Average θₐ, θᵣ and wetting hysteresis measured before and after surface treatments are summarized in Table 3 along with their grouping according to the Tukey-test. The first striking feature in considering θₐ is the large reduction induced by the oxygen plasma treatment from 100±7° to 35±14°, which can indicate improved wettability (Table 3). FIG. 2 illustrates an advancing contact angle of WPC formulations both before and after surface treatments. As shown in FIG. 2, the water θₐ was consistently reduced for all formulations after the plasma treatment. The reduction in the water θₐ following the plasma treatment may have been induced by a decrease in the substrate hydrophobicity or roughness. The water θᵣ also decreased after the plasma treatment (Table 3) further supporting the enhanced substrate hydrophilicity. Indeed, for heterogeneous surfaces having both a hydrophobic and hydrophilic component, the advancing contact angle reflects the hydrophobic component, whereas the receding contact angle is dictated by the hydrophilic component. Improved water wettability in oxygen plasma treated WPCs can be due to surface oxidation, although this was not clearly detected from the ATR-FTIR. The improved wettability of WPCs with polar liquids after the plasma treatment likely contributes to adhesion improvement with a water-based acrylic coating.

In contrast, the BP/UV (140±100) and the chromic acid treatments (120±190) actually increased the θₐ compared to the control WPCs (100±70), suggesting a more hydrophobic surface and lower wettability (Table 3). The flame treatment did not alter the advancing contact angle. In the examples described above, changes in θₐ with surface treatments were consistently observed for all the formulations (see FIG. 2). For all the treatments, θᵣ also decreased to 0 (Table 3). For hydrophobic surfaces, such as WPCs, surface roughening can increase θₐ upon wetting but also decrease θᵣ upon de-wetting as water gets trapped in the surface asperities. The trends in dynamic contact angles observed after the treatments with chromic acid and BP/UV are consistent with a surface roughening induced by the treatments. The effectiveness of the chromic acid and BP/UV treatments at improving coating adhesion to WPCs may be related at least in part to their effects on the substrate topography.

### D4. Impact of Surface Treatments on WPC Surface Topography

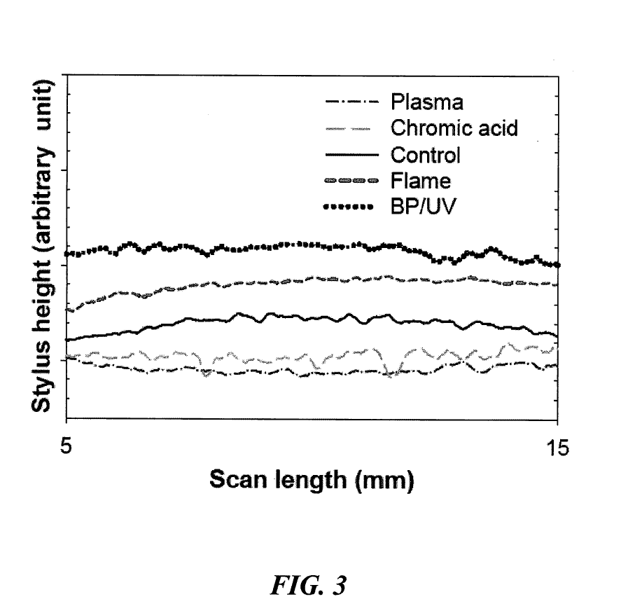

To further test whether the treatments had affected surface roughness, the topography of HDPE/Pine/MAPP formulation before and after treatments was qualitatively compared using both profilometry and scanning electron microscopy. FIG. 3 is a graphical representation of surface topography of a HDPE/Pine/MAPP formulation both before and after surface treatments. As shown, the chromic acid treated WPC formulation displayed larger variations in topography, indicating higher surface roughness than all other surfaces. FIG. 3 also shows that, after treatments with BP/UV, plasma and flame, the topographies were similar to those of the untreated WPCs.

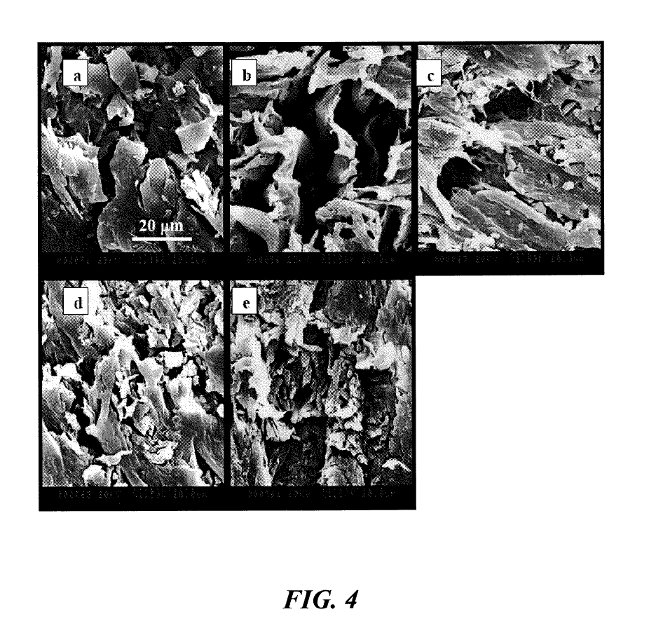

FIGS. 4(a)-(e) are, respectively, scanning electron microscopy (1.5 K magnification) images of a HDPE/Pine/MAPP formulation a) before treatment, and after treatments with b) chromic acid, c) flame, d) BP/UV and e) oxygen plasma. SEM images of the samples before and after treatments confirm the observations from the profilometry. For example, large crevasses formed on the WPC surface as a result of the chromic acid treatment are evident; however, crevasses are not observed the WPC surfaces following the other treatments (e.g., flame, BP/UV and oxygen plasma). Although qualitative, these images are consistent with WPC surface adhesion enhancement following chromic acid treatment due to roughening.

### D5. Adhesion Mechanisms of Surface Treatments

Because surface roughness, chemical heterogeneity and viscoelastic energy dissipation mechanisms all contribute to both wetting hysteresis and adhesion, a strong correlation (r²=0.89) between the water wetting hysteresis and the adhesion of a water-based acrylic coating on WPCs exists. In the examples described above, all but the oxygen plasma treatment significantly increased the wetting hysteresis of WPCs (Table 3). The BP/UV treatment (128±8 mJ/m²) increased the wetting hysteresis to the greatest degree when compared to the other methods, followed by the chromic acid treatment (107±20 mJ/m²) and finally the flame treatment (90±17 mJ/m²) (Table 3). The increase in wetting hysteresis for the BP/UV, chromic acid and flame treatments is, therefore, consistent with the improved adhesion of the coating following these surface treatments.

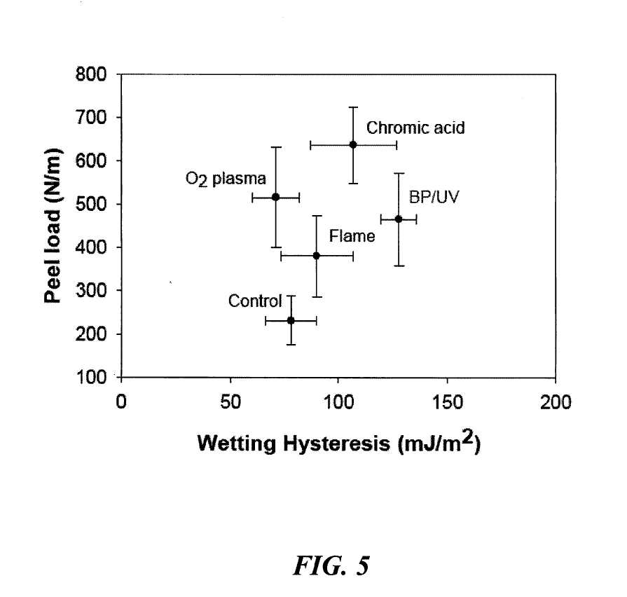

To further comprehend the adhesion mechanisms in place following the surface treatments, relationships between peel load and surface wood content (O—H/C—H), contact angle (θₐ) and wetting hysteresis were evaluated. In the case of treated WPCs, no distinct relationships could be established between the peel load and any surface properties. FIG. 5 is a graphical representation of the peel load (N/m) dependency of WPC formulations on wetting hysteresis. At most, an ascending trend of peel load with wetting hysteresis may be suggested. The lack of distinct relationship likely reflects the greater complexity and diversity of adhesion mechanisms in action with the various surface treatments.

### D6. Summary

One of the problems in applying coating to wood plastic composites is the difficulty with adhesion, due to the low surface energy of the wood plastic composites. In some embodiments, to improve the adhesion properties of WPCs, wood plastic composite formulations can be treated with various surface activation methods including treatments with: 1) oxygen plasma, 2) flame, 3) chromic acid, and 4) a combination of benzophenone/UV irradiation. These surface activation methods can improve the adhesion to WPCs dramatically. For instance, the adhesion of a water-based acrylic coating to WPCs, as measured by a 1800 peel test, was improved by about 170% (e.g., approximately 130%-200%) and about 122% (e.g., approximately 90%-140%) following treatments with the chromic acid and the oxygen plasma, respectively. In fact, these treatments enabled adhesion levels to WPCs that were equal to or greater than those obtained on maple. Following treatments with the benzophenone/UV and flame, the adhesion of the water-based acrylic coating can be improved by about 100% (e.g., approximately 70%-130%) and about 67% (e.g., approximately 40%-80%), respectively.

Various embodiments of the technology are described above. It will be appreciated that details set forth above are provided to describe the embodiments in a manner sufficient to enable a person skilled in the relevant art to make and use the disclosed embodiments. Several of the details and advantages, however, may not be necessary to practice some embodiments. Additionally, some well-known structures or functions may not be shown or described in detail, so as to avoid unnecessarily obscuring the relevant description of the various embodiments. Although some embodiments may be within the scope of the claims, they may not be described in detail with respect to the Figures. Furthermore, features, structures, or characteristics of various embodiments may be combined in any suitable manner. Moreover, one skilled in the art will recognize that there are a number of other technologies that could be used to perform functions similar to those described above and so the claims should not be limited to the devices or methods described herein. While some processes are described in a given order, alternative embodiments may perform methods having steps in a different order, and some processes may be deleted, moved, added, subdivided, combined, and/or modified. Accordingly, each of these methods may be implemented in a variety of different ways. Also, while some methods (e.g., surface modification methods) are at times shown as being performed in series, these methods may instead be performed in parallel, or may be performed at different times. The headings provided herein are for convenience only and do not interpret the scope or meaning of the claims.

The terminology used in the description is intended to be interpreted in its broadest reasonable manner, even though it is being used in conjunction with a detailed description of identified embodiments.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. When the claims use the word “or” in reference to a list of two or more items, that word covers all of the following interpretations of the word: any of the items in the list, all of the items in the list, and any combination of the items in the list.

Any patents, applications and other references, including any that may be listed in accompanying filing papers, are incorporated herein by reference. Aspects of the described technology can be modified, if necessary, to employ the systems, functions, and concepts of the various references described above to provide yet further embodiments.

These and other changes can be made in light of the above Detailed Description. While the above description details certain embodiments and describes the best mode contemplated, no matter how detailed, various changes can be made. Implementation details may vary considerably, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the claims to the specific embodiments disclosed in the specification, unless the above Detailed Description section explicitly defines such terms. Accordingly, the actual scope of the claims encompasses not only the disclosed embodiments, but also all equivalents.

We claim:

1. A method for treating the surface of a wood plastic composite material to enhance its surface adhesion properties to a water-based acrylic coating material, the method comprising the use of at least one of the following surface activation methods:
i) oxygen plasma treatment to increase a wettability of the wood plastic composite material with polar liquids, wherein the oxygen plasma treatment includes exposing the wood plastic composite material to a oxygen plasma for a predetermined time exposure;
ii) flame treatment for increasing an acrylic coating peel load, wherein the flame treatment includes exposing the wood composite material to a flame at a predetermined distance from the flame;
iii) chromic acid treatment for roughening of a surface of the wood plastic composite material, wherein the chromic acid treatment includes applying a chromic acid solution to the surface of the wood plastic composite material; and
iv) benzophenone/UV irradiation (BP/UV) treatment for increasing an acrylic coating peel load, wherein the BP/UV treatment includes immersing the wood plastic composite material in a benzophenone-solvent solution, evaporating the solvent, and UV irradiating the wood plastic composite material.

2. The method of claim 1 wherein the wood plastic composite material includes high density polyethylene and a natural wood.

3. The method of claim 1 wherein the wood plastic composite material includes isotactic polypropylene and a natural wood.

4. The method of claim 1 wherein the wood plastic composite material includes maleic anhydride grafted polypropylene (MAPP) coupling agent.

5. The method of claim 1 wherein oxygen plasma is generated in a plasma reactor, and wherein the predetermined time exposure is approximately 5 minutes to approximately 60 minutes.

6. The method of claim 1 wherein applying a chromic acid solution includes immersing the wood plastic composite material in the chromic acid solution under constant stirring.

7. The method of claim 1 wherein the flame treatment is performed with a flame generator, and wherein the method includes:
mixing air and gas in a vessel to generate a flame; and
moving the wood plastic composite material under the flame, wherein the predetermined distance is approximately 5 mm to approximately 50 mm, and wherein moving includes moving at a speed of approximately 0.1 m/s to approximately 0.9 m/s.

8. The method of claim 1 wherein the benzophenone/UV irradiation treatment includes:
immersing the wood plastic composite material for approximately 0.5 minutes to approximately 5 minutes in the benzophenone-solvent solution, wherein the solvent is acetone;
irradiating the wood plastic composite material under a metal halogenide lamp for approximately 1 minute to approximately 5 minutes; and
washing the wood plastic composite material with acetone to remove residual BP.

9. A method for enhancing surface adhesion properties of a wood plastic composite (WPC) material to an acrylic coating material, the method comprising:
applying a chromic acid solution to a surface of the WPC material to roughen the surface; and
exposing the surface of the WPC material to oxygen plasma for increasing a wettability of the surface of the WPC material with polar liquids.

10. The method of claim 9 wherein the oxygen plasma is generated in a reactor with a coil operating at a radio frequency of about 12 MHz to about 15 MHz, at a temperature of about 20° C. to about 25° C., and a base pressure approximately less than 3×10⁻⁶ MPa.

11. The method of claim 10 wherein the WPC material is exposed to the oxygen plasma for approximately 10 minutes to approximately 30 minutes at approximately 0.11×10⁻³ MPa to approximately 0.013×10⁻³ MPa pressure, and with approximately a 10 sccm to approximately 52 sccm oxygen flow rate.

12. The method of claim 9 wherein applying a chromic acid solution includes immersing the WPC material in a chromic acid solution during constant stirring, and wherein the method further includes washing and drying the WPC material.

13. The method of claim 9 wherein the WPC material includes isotactic polypropylene, a natural wood and a maleic anhydride grafted polypropylene (MAPP) coupling agent.

14. The method of claim 13 wherein the natural wood is one of pine and maple.

15. A surface-modified wood plastic composite (WPC) material having at least one surface having enhanced adhesion properties, the WPC material comprising:
a natural wood;
a polymer, wherein the polymer includes at least one of high density polyethylene and isotactic polypropylene; and
optionally, a maleic anhydride grafted polypropylene (MAPP) coupling agent;
wherein the surface-modified WPC material has a roughened surface, a decreased surface wood index, and oxygen-containing functional groups on the at least one surface.

16. The material of claim 15, further comprising a water-based acrylic coating on the at least one surface, wherein the water-based acrylic coating has an increased adherence to the at least one surface when compared to a non-modified WPC material surface.

17. The material of claim 16 wherein the WPC material has an increased acrylic coating peel load of at least 170% when compared to an acrylic coating peel load of the non-modified WPC material surface.

18. The material of claim 16 wherein the WPC material has an increased acrylic coating peel load of at least 120% when compared to an acrylic coating peel load of the non-modified WPC material surface.
